(19) United States
(12) Patent Application Publication
(10) Pub. No.: US 2025/0233347 A1
(43) Pub. Date: Jul. 17, 2025

(54) Electrical Connector

(71) Applicants: Dongguan Tarng Yu Electronics Co., Ltd., Dongguan City (CN); Tarng Yu Enterprise co., ltd., New Taipei City (TW)

(72) Inventors: TSUNG-CHI CHEN, New Taipei City (TW); MU-JUNG HUANG, New Taipei City (TW)

(21) Appl. No.: 19/017,338

(22) Filed: Jan. 10, 2025

(30) Foreign Application Priority Data
Jan. 12, 2024 (TW) 113200484

(51) Int. Cl. H01R 13/506; H01R 13/424; H01R 13/631; H01R 13/66

(52) U.S. Cl. CPC H01R 13/506; H01R 13/424; H01R 13/631; H01R 13/6658

(57) ABSTRACT

An electrical connector, which is assembled and constructed from multiple components with conductive terminals. Therefore, the electrical connector can be customized by altering the conductive terminals of the assembled components to adjust the number and configuration of the conductive terminals, enabling the electrical connector to meet the requirements of electronic devices.

### CROSS-REFERENCE TO RELATED APPLICATIONS

This application claims the priority of Republic of China Patent Application No. 113200484 filed on Jan. 12, 2024, in the State Intellectual Property Office of the R.O.C., the disclosure of which is incorporated herein by reference.

### BACKGROUND OF THE INVENTION

### Field of the Invention

This application relates to an electrical connector, and more specifically, to an electrical connector assembled from multiple components.

### Descriptions of the Related Art

Electrical connectors are widely used in various electronic devices. In recent years, electrical connectors can be paired with inserting components. Generally speaking, electrical connectors are equipped with conductive terminals, which connect with the paired inserting components. This allows the conductive terminals and the inserting components to form a signal transmission component, enabling the transmission of electrical signals within electronic devices.

To meet the demands of electronic devices, the quantity and configuration of the conductive terminals in electrical connectors are required to be customizable. However, once the design of an electrical connector is completed, the quantity and configuration of the conductive terminals are fixed and cannot be adjusted.

In view of the above, how to achieve customizable adjustment of the quantity and configuration of conductive terminals in electrical connectors becomes a technical challenge that the industry is eager to address and overcome.

### SUMMARY OF THE INVENTION

In view of the drawbacks of the prior art mentioned above, the present application provides an electrical connector, the electrical connector can allow an inserting component to insert in order to transmit a major-side bridging signal and a major-side non-bridging signal, the inserting component comprises a major-side inserting component inserting section and a minor-side inserting component inserting section, the electrical connector comprises: a major-side electrical connector subcomponent, the major-side electrical connector subcomponent comprises a major-side conductive terminal assembly, a major-side circuit board, a major-side processing module, and a major-side insulation carrier, the major-side circuit board comprises a major-side bridging circuit and a major-side non-bridging circuit, the major-side processing module comprises a major-side processing module bridging pin and a major-side processing module non-bridging pin, the major-side conductive terminal assembly comprises a major-side conductive terminal inserting section, a first major-side bridging conductive terminal, a second major-side bridging conductive terminal, and a major-side non-bridging conductive terminal, the major-side insulation carrier comprises a major-side carrier embedded space, wherein the major-side bridging circuit is electrically connected to the first major-side bridging conductive terminal and the second major-side bridging conductive terminal to transmit the major-side bridging signal; the major-side non-bridging circuit is electrically connected to the major-side non-bridging conductive terminal to transmit the major-side non-bridging signal; the major-side processing module bridging pin is electrically connected to the major-side bridging circuit, and the major-side processing module non-bridging pin is electrically connected to the major-side non-bridging circuit, enabling the major-side processing module to respectively receive the major-side bridging signal and the major-side non-bridging signal for processing; and the major-side insulation carrier provides support for the major-side circuit board, the major-side conductive terminal assembly, and the major-side processing module, while the major-side carrier embedded space provides embedding for at least a portion of the major-side processing module; a minor-side electrical connector subcomponent, the minor-side electrical connector subcomponent comprises a minor-side conductive terminal assembly, and the minor-side conductive terminal assembly comprises a minor-side conductive terminal inserting section; and an electrical connector insulation housing, the electrical connector insulation housing comprises an electrical connector housing body, a major-side housing assembly space, a minor-side housing assembly space, a major-side housing inserting space, and a minor-side housing inserting space; the electrical connector housing body can guide the major-side electrical connector subcomponent into the major-side housing assembly space, so as to enable the major-side conductive terminal inserting section to enter the major-side housing inserting space, and the electrical connector housing body further guides the minor-side electrical connector subcomponent into the minor-side housing assembly space, enabling the minor-side conductive terminal inserting section to enter the minor-side housing inserting space; the electrical connector housing body further guides the inserting component, enabling the major-side inserting component inserting section to enter the major-side housing inserting space and insert the major-side conductive terminal inserting section, and further enabling the minor-side inserting component inserting section to enter the minor-side housing inserting space and insert the minor-side conductive terminal inserting section.

Preferably, the electrical connector said above, further comprising an electrical connector cover, the electrical connector cover comprises a major-side electrical connector cover stop structure and a minor-side electrical connector cover stop structure, and the electrical connector cover can insert the electrical connector insulation housing, enabling the major-side electrical connector cover stop structure to provide stopping for the major-side electrical connector subcomponent to prevent the major-side conductive terminal inserting section from leaving the major-side housing inserting space, and further enabling the minor-side electrical connector cover stop structure to provide stopping for the minor-side electrical connector subcomponent to prevent the minor-side conductive terminal inserting section from leaving the minor-side housing inserting space.

Preferably, the electrical connector said above, is further able to transmit a minor-side bridging signal and a minor-side non-bridging signal, the minor-side electrical connector subcomponent further comprises a minor-side bridging cable and a minor-side non-bridging cable, the minor-side conductive terminal assembly comprises a first minor-side bridging conductive terminal, a second minor-side bridging conductive terminal, and a minor-side non-bridging conductive terminal, wherein the minor-side bridging cable is electrically connected to the first minor-side bridging conductive terminal and the second minor-side bridging conductive terminal to transmit the minor-side bridging signal, and the minor-side non-bridging cable is electrically connected to the non-bridging conductive terminal to transmit the minor-side non-bridging signal.

Preferably, the electrical connector said above, further comprises an electrical connector cover, the electrical connector cover comprises a cover threading passage, wherein the minor-side non-bridging cable passes through the electrical connector cover via the cover threading passage.

Preferably, the electrical connector said above, wherein the first major-side bridging conductive terminal, the second major-side bridging conductive terminal, and the major-side non-bridging conductive terminal are respectively inserting terminals for inserting the major-side circuit board or soldering terminals for soldering the major-side circuit board.

Preferably, the electrical connector said above, wherein the major-side insulation carrier further comprises a major-side carrier positioning structure, the major-side carrier positioning structure provides positioning for the major-side circuit board to prevent the major-side processing module from being misaligned with the major-side carrier embedded space.

Preferably, the electrical connector said above, wherein the major-side insulation carrier comprises a major-side carrier assembly structure, the major-side carrier assembly structure is assembled to the electrical connector housing body to restrict the movement of the major-side electrical connector subcomponent relative to the electrical connector housing body.

Preferably, the electrical connector said above, wherein the minor-side conductive terminal assembly comprises a minor-side conductive terminal assembly structure, the minor-side conductive terminal assembly structure is assembled to the electrical connector housing body to restrict the movement of the minor-side electrical connector subcomponent relative to the electrical connector housing body.

Preferably, the electrical connector said above, wherein the electrical connector housing body comprises a housing body support frame, the housing body support frame is located between the major-side housing assembly space and the minor-side housing assembly space, and the housing body support frame extends along the periphery of the major-side housing assembly space to form a drawer structure for supporting the major-side electrical connector subcomponent.

Preferably, the electrical connector said above, wherein the housing body support frame comprises a housing body support frame guiding structure, and the housing body support frame guiding structure can guide the major-side electrical connector subcomponent into the major-side housing assembly space.

Compared to prior art, this application provides an electrical connector assembled from multiple components with conductive terminals. Consequently, the quantity of conductive terminals in the electrical connector can be customized and adjusted to meet the requirements of electronic devices by changing the number of conductive terminals in the assembled components. Additionally, the electrical connector comprises a circuit board capable of electrically connecting to the conductive terminals, and the circuit board is equipped with a processing module that can process signals. This ensures that the electrical characteristics of the electrical connector meet the requirements of electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic view of the electrical connector in a first perspective of an embodiment of this application.

FIG. 2 is a three-dimensional schematic view of the electrical connector in a second perspective of an embodiment of this application.

FIG. 3 is a three-dimensional schematic view of the electrical connector in a third perspective of an embodiment of this application.

FIG. 4 is a three-dimensional schematic view of some components of the electrical connector in a first perspective of an embodiment of this application.

FIG. 5 is a three-dimensional schematic view of some components of the electrical connector in a second perspective of an embodiment of this application.

FIG. 6 is a three-dimensional schematic view of some components of the electrical connector in a first perspective of an embodiment of this application.

FIG. 7 is a three-dimensional schematic view of some components of the electrical connector in a second perspective of an embodiment of this application.

FIG. 8 is a three-dimensional schematic view of some components of the electrical connector in a first perspective of an embodiment of this application.

FIG. 9 is a three-dimensional schematic view of some components of the electrical connector in a second perspective of an embodiment of this application.

FIG. 10 is a three-dimensional schematic view of some components of the electrical connector in an embodiment of this application.

FIG. 11 is a three-dimensional schematic view of some components of the electrical connector in an embodiment of this application.

FIG. 12 is a three-dimensional schematic view of some components of the electrical connector in an embodiment of this application.

FIG. 13 is a three-dimensional schematic view of some components of the electrical connector in an embodiment of this application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Furthermore, in the following embodiments, structures or components with the same or similar functions will be described using the same symbols, and descriptions of identical or equivalent technical features will be omitted to make the disclosed content more concise and easier to understand.

This application provides an electrical connector, which is assembled from multiple components with conductive terminals. Consequently, the electrical connector can customize and adjust the number and configuration of conductive terminals by changing the components being assembled, allowing the electrical connector to meet the needs of electronic devices.

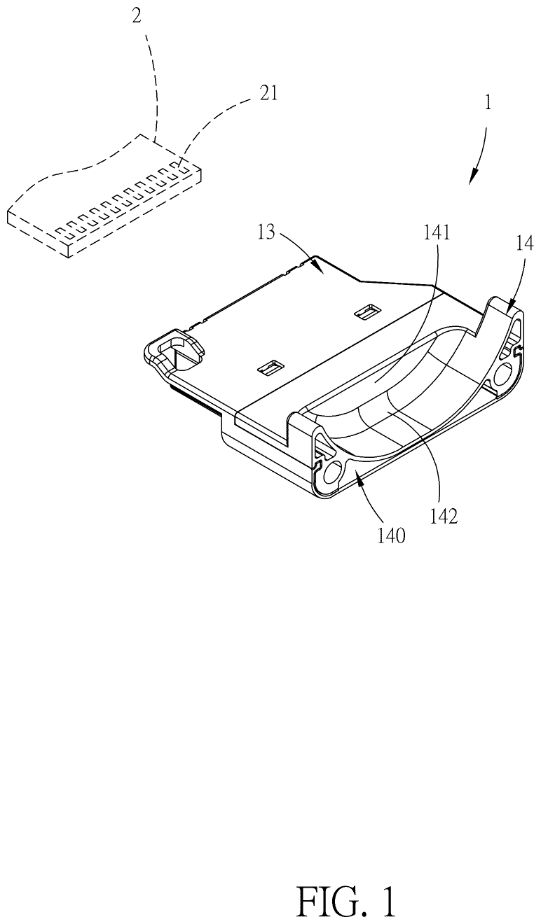

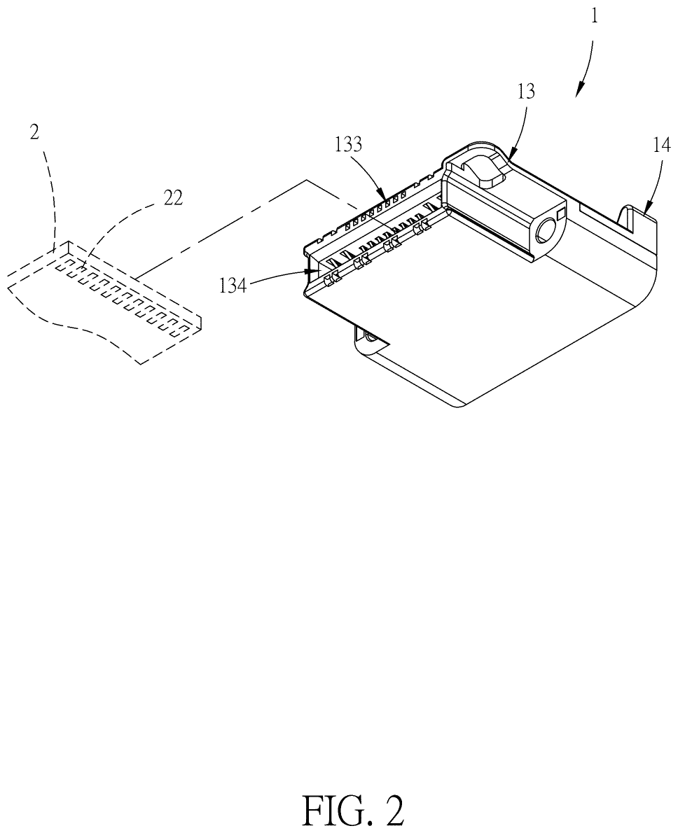

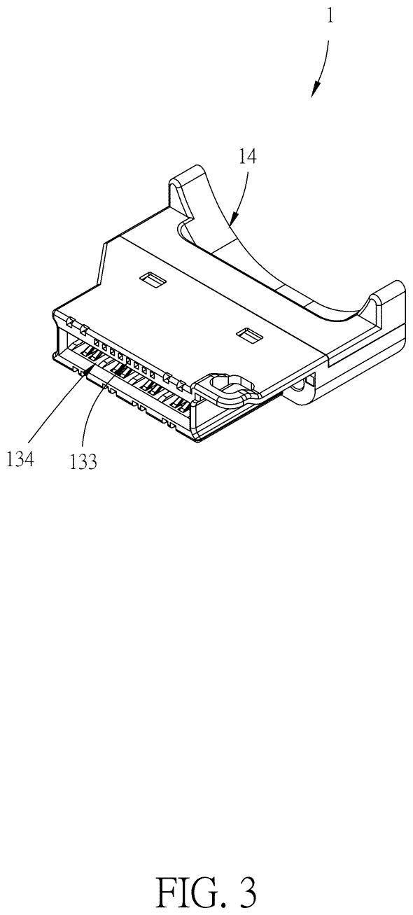

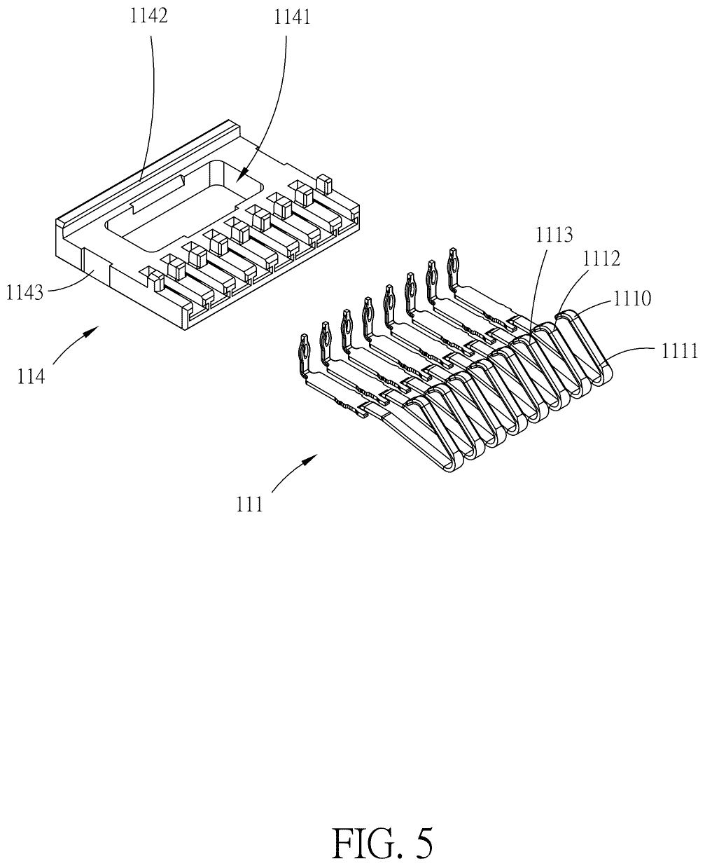

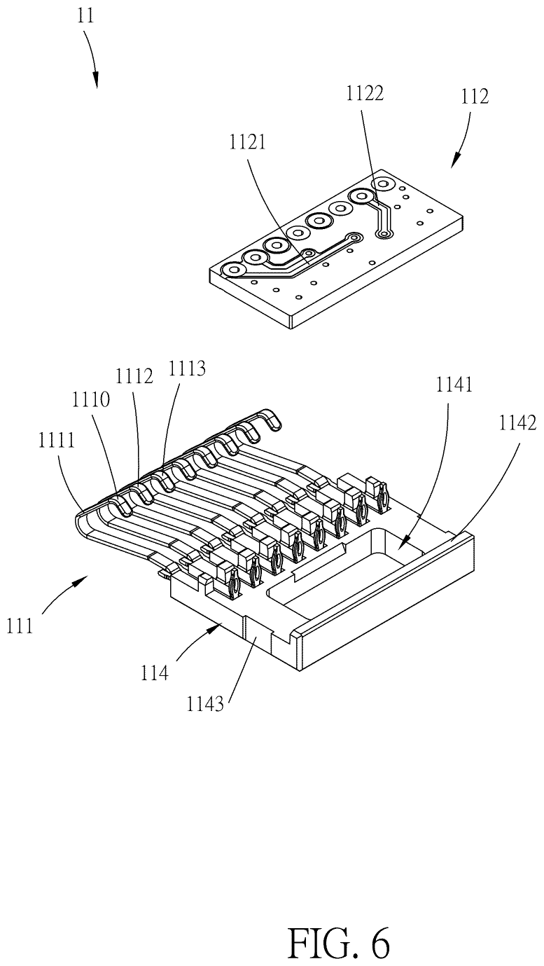

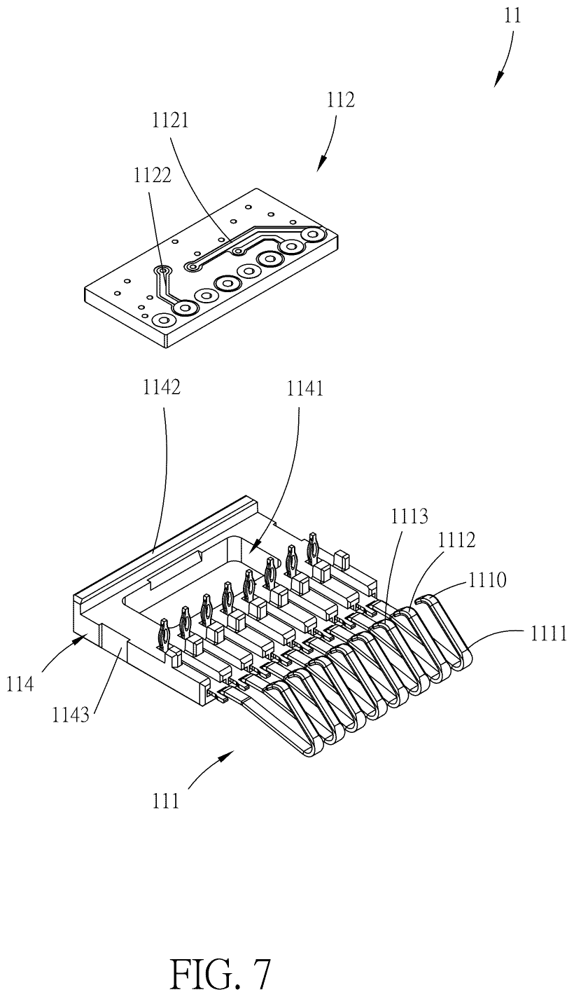

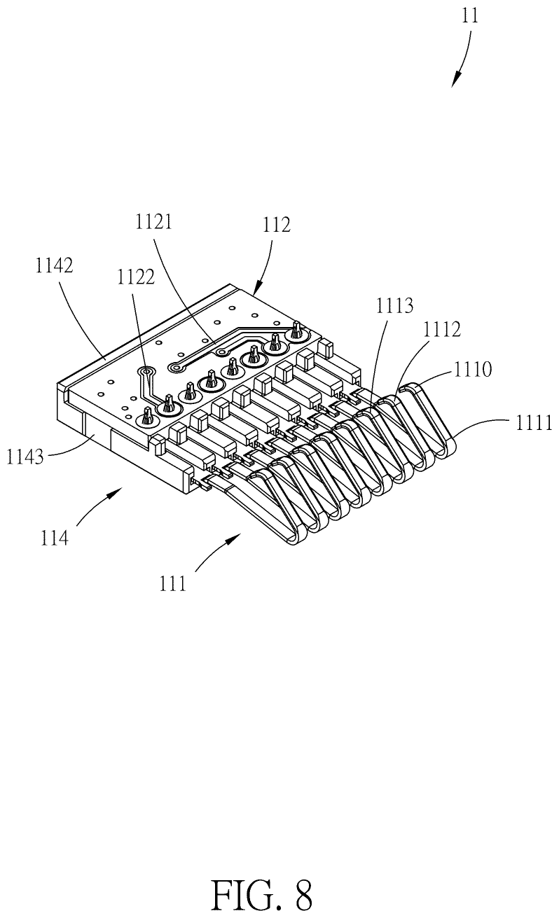

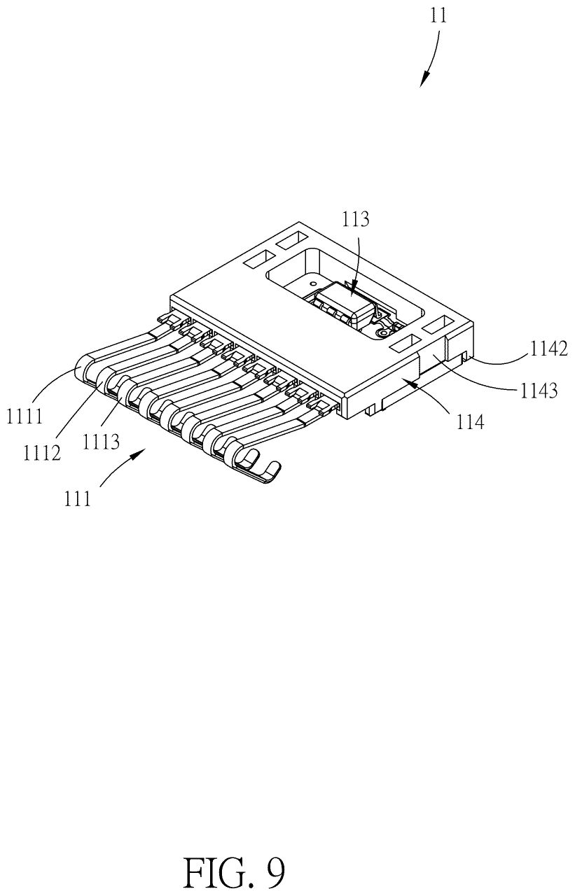

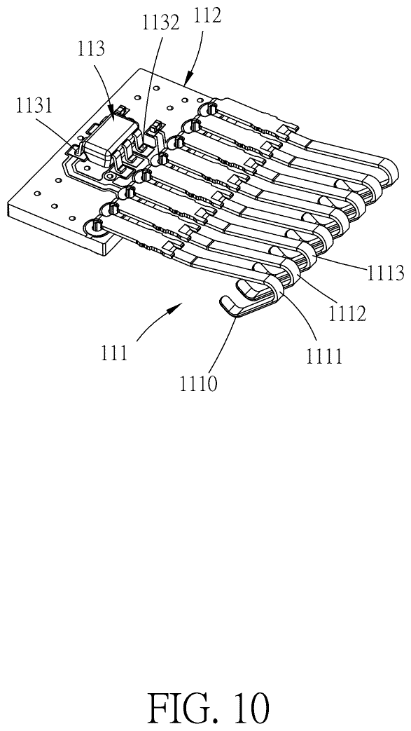

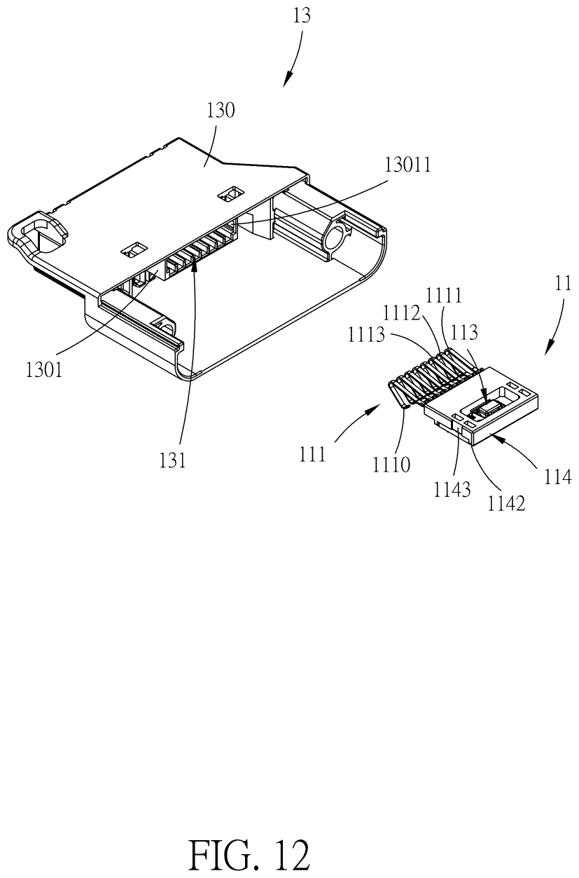

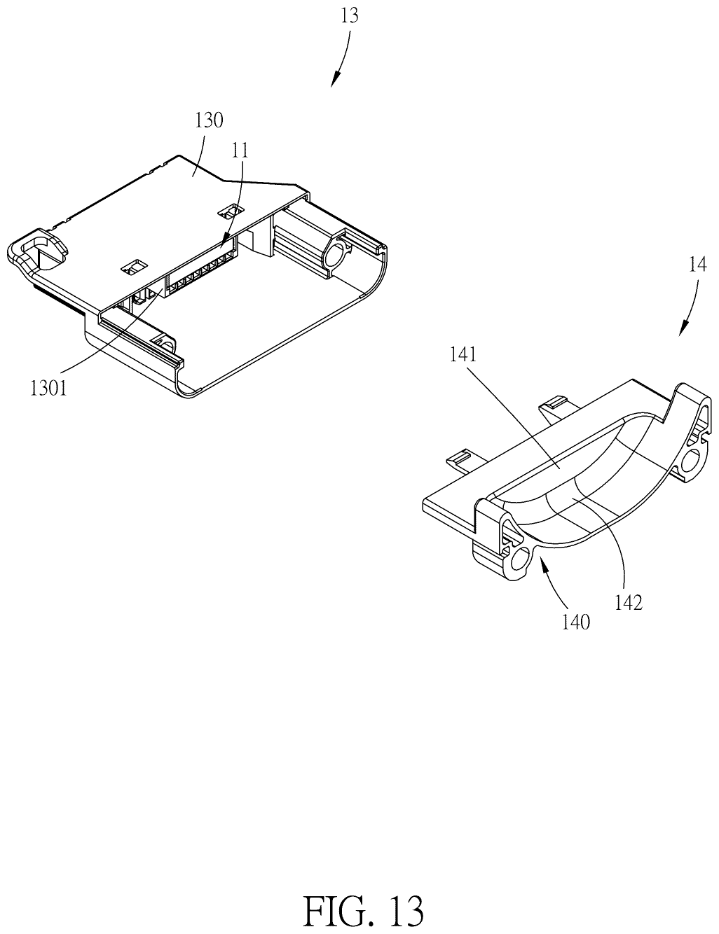

Regarding the technical concepts of this application, please refer to the descriptions of the embodiments shown in FIGS. 1 to 13.

In the embodiments shown in FIGS. 1 to 13, at least an electrical connector 1 is disclosed. The electrical connector 1 is capable of inserting an inserting component 2 to transmit a major-side bridging signal, a major-side non-bridging signal, a minor-side bridging signal, and a minor-side non-bridging signal. It should be noted that the inserting component 2 can optionally be an electrical connector or a circuit board and comprises an inserting component inserting structure, such as a tongue-shaped inserting structure, which comprises a major-side inserting component inserting section 21 and a minor-side inserting component inserting section 22. The major-side inserting component inserting section 21 and the minor-side inserting component inserting section 22, for example, provide a circuit structure capable of transmitting electrical signals via inserting.

The electrical connector 1 comprises: a major-side electrical connector subcomponent 11, a minor-side electrical connector subcomponent 12, an electrical connector insulation housing 13, and an electrical connector cover 14.

As for the major-side electrical connector subcomponent 11, the major-side electrical connector subcomponent 11 comprises a major-side conductive terminal assembly 111, a major-side circuit board 112, a major-side processing module 113, and a major-side insulation carrier 114. Among them, the major-side circuit board 112 comprises a major-side bridging circuit 1121 and a major-side non-bridging circuit 1122. The major-side processing module 113 comprises a major-side processing module bridging pin 1131 and a major-side processing module non-bridging pin 1132. The major-side conductive terminal assembly 111 comprises a major-side conductive terminal assembly inserting section 1110, a first major-side bridging conductive terminal 1111, a second major-side bridging conductive terminal 1112, and a major-side non-bridging conductive terminal 1113. The major-side insulation carrier 114 comprises a major-side carrier embedded space 1141, a major-side carrier positioning structure 1142, and a major-side carrier assembly structure 1143.

It should be noted that, in the aforementioned embodiment, the major-side bridging circuit 1121 electrically connects the first major-side bridging conductive terminal 1111 and the second major-side bridging conductive terminal 1112 to transmit the major-side bridging signal. Consequently, the major-side circuit board 112 enables electrical connections among multiple conductive terminals on the electrical connector 1, ensuring that the electrical characteristics of the electrical connector 1 meet the requirements of electronic devices. Additionally, the major-side non-bridging circuit 1122 electrically connects the major-side non-bridging conductive terminal 1113 to transmit the major-side non-bridging signal.

Furthermore, the major-side processing module bridging pin 1131 is electrically connected to the major-side bridging circuit 1121, and the major-side processing module non-bridging pin 1132 is electrically connected to the major-side non-bridging circuit 1122, enabling the major-side processing module 113 to be installed on the major-side circuit board 112 to separately receive and process the major-side bridging signal and the major-side non-bridging signal. In this manner, the major-side processing module 113 can be directly installed within the electrical connector 1 via the major-side circuit board 112 to process electrical signals. Optionally, the major-side processing module 113 can be a chip module, ensuring that the electrical characteristics of the electrical connector 1 meet the requirements of electronic devices.

Regarding the major-side insulation carrier 114, it supports the major-side circuit board 112, the major-side conductive terminal assembly 111, and the major-side processing module 113. The major-side carrier embedded space 1141 is provided for embedding at least a portion of the major-side processing module 113. This design reduces the extent to which the major-side processing module 113 protrudes from the major-side insulation carrier 114, thereby effectively minimizing the size of the electrical connector 1 and enabling the electronic device equipped with the electrical connector 1 to continue evolving toward a thinner and more compact form factor. Correspondingly, the major-side carrier positioning structure 1142 ensures the positioning of the major-side circuit board 112, preventing misalignment between the major-side processing module 113 and the major-side carrier embedded space 1141, thus ensuring that the major-side carrier embedded space 1141 can embed at least a portion of the major-side processing module 113.

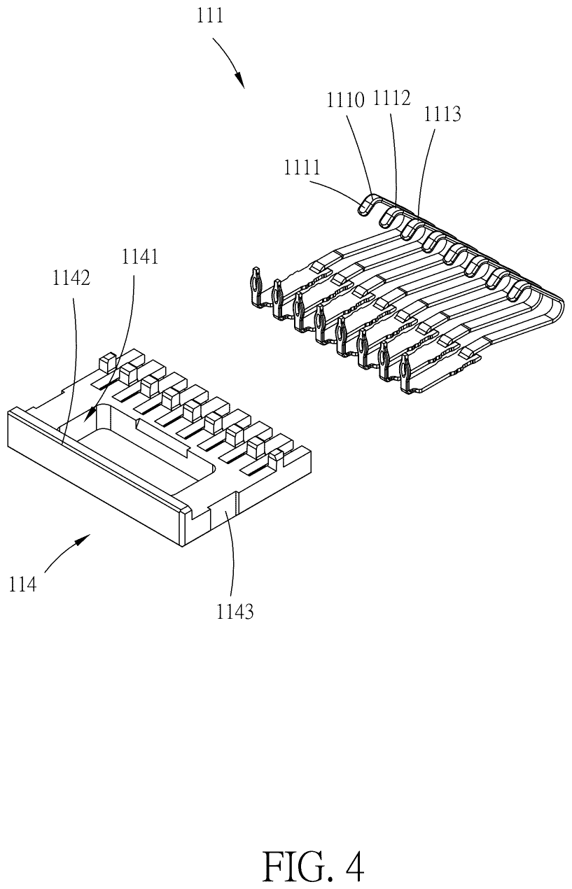

In the embodiments shown in FIGS. 4 to 10 and FIG. 12, the first major-side bridging conductive terminal 1111, the second major-side bridging conductive terminal 1112, and the major-side non-bridging conductive terminal 1113 are inserting terminals that can be inserted into the major-side circuit board 112. However, this is not a limitation. For example, the first major-side bridging conductive terminal 1111, the second major-side bridging conductive terminal 1112, and the major-side non-bridging conductive terminal 1113 can also be soldering terminals that can be soldered to the major-side circuit board 112. Optionally, the first major-side bridging conductive terminal 1111, the second major-side bridging conductive terminal 1112, and the major-side non-bridging conductive terminal 1113 can have substantially the same configuration, enabling batch production to reduce manufacturing costs.

Regarding the minor-side electrical connector subcomponent 12, the minor-side electrical connector subcomponent 12 comprises a first minor-side conductive terminal assembly 121, a first minor-side bridging cable 122, and a first minor-side non-bridging cable 123. Among these, the minor-side conductive terminal assembly 121 comprises a minor-side conductive terminal assembly inserting section 1210, a first minor-side bridging conductive terminal 1211, a second minor-side bridging conductive terminal 1212, a minor-side non-bridging conductive terminal 1213, and a minor-side conductive terminal assembly structure 1214. Additionally, the minor-side bridging cable 122 and the minor-side non-bridging cable 123 are, for example, conductive cables.

Optionally, the first minor-side bridging conductive terminal 1211, the second minor-side bridging conductive terminal 1212, and the minor-side non-bridging conductive terminal 1213 may have substantially identical shapes, allowing for mass production of the first minor-side bridging conductive terminal 1211, the second minor-side bridging conductive terminal 1212, and the minor-side non-bridging conductive terminal 1213 to reduce manufacturing costs.

It should be noted that, in the above embodiments, the minor-side bridging cable 122 electrically connects the first minor-side bridging conductive terminal 1211 and the second minor-side bridging conductive terminal 1212 to transmit the minor-side bridging signal. As a result, the minor-side bridging cable 122 achieves the electrical connection of multiple conductive terminals in the electrical connector 1, ensuring that the electrical performance of the electrical connector 1 meets the requirements of electronic devices. Moreover, the minor-side non-bridging cable 123 electrically connects the non-bridging conductive terminals to transmit the minor-side non-bridging signal.

Regarding the electrical connector insulation housing 13, the electrical connector insulation housing 13 is made of an insulating material and comprises an electrical connector housing body 130, a major-side housing assembly space 131, a minor-side housing assembly space 132, a major-side housing inserting space 133, and a minor-side housing inserting space 134.

It should be noted that, in the above embodiments, the electrical connector housing body 130 can guide the major-side electrical connector subcomponent 11 into the major-side housing assembly space 131, allowing the major-side conductive terminal assembly inserting section 1110 to enter the major-side housing inserting space 133. This reduces the extent to which the major-side electrical connector subcomponent 11 protrudes from the electrical connector housing body 130, effectively minimizing the size of the electrical connector 1 and enabling the electronic device incorporating the electrical connector 1 to develop in the direction of being more compact and lightweight. Furthermore, during the process of the major-side electrical connector subcomponent 11 entering the major-side housing assembly space 131, the major-side carrier assembly structure 1143 can be assembled to the electrical connector housing body 130 to restrict the movement of the major-side electrical connector subcomponent 11 relative to the electrical connector housing body 130.

Additionally, in the above embodiments, the electrical connector housing body 130 can also guide the minor-side electrical connector subcomponent 12 into the minor-side housing assembly space 132. This reduces the extent to which the minor-side electrical connector subcomponent 12 protrudes from the electrical connector housing body 130, effectively minimizing the size of the electrical connector 1 and enabling the electronic device incorporating the electrical connector 1 to develop in the direction of being more compact and lightweight.

Furthermore, during the process of the minor-side electrical connector subcomponent 12 entering the minor-side housing assembly space 132, the minor-side conductive terminal assembly structure 1214 can be assembled to the electrical connector housing body 130 to restrict the movement of the minor-side electrical connector subcomponent 12 relative to the electrical connector housing body 130.

Additionally, in the above embodiments, the electrical connector housing body 130 can guide the inserting component 2 to insert. This allows the major-side inserting component inserting section 21 to enter the major-side housing inserting space 133 and insert the major-side conductive terminal assembly inserting section 1110 to provide electrical signal transmission. In this way, the major-side conductive terminal assembly 111 can electrically connect with the major-side inserting component inserting section 21 to transmit the major-side bridging signal and the major-side non-bridging signal. Furthermore, during the process of the electrical connector housing body 130 guiding the inserting component 2 to insert, the minor-side inserting component inserting section 22 can enter the minor-side housing inserting space 134 and insert the minor-side conductive terminal assembly inserting section 1210 to provide electrical signal transmission. In this way, the minor-side conductive terminal assembly 121 can electrically connect with the minor-side inserting component inserting section 22 to transmit the minor-side bridging signal and the minor-side non-bridging signal.

Regarding the electrical connector cover 14, the electrical connector cover 14 comprises a cover threading passage 140, a major-side electrical connector cover stop structure 141, and a minor-side electrical connector cover stop structure 142. The electrical connector cover 14 can be engaged with the electrical connector insulation housing 13, enabling the major-side electrical connector cover stop structure 141 to provide a stop for the major-side electrical connector subcomponent 11, preventing the major-side conductive terminal assembly inserting section 1110 from exiting the major-side housing inserting space 133. Additionally, after the electrical connector cover 14 is engaged with the electrical connector insulation housing 13, the minor-side electrical connector cover stop structure 142 can provide a stop for the minor-side electrical connector subcomponent 12, preventing the minor-side conductive terminal assembly inserting section 1210 from exiting the minor-side housing inserting space 134. At this point, the minor-side non-bridging cable 123 can pass through the cover threading passage 140 of the electrical connector cover 14.

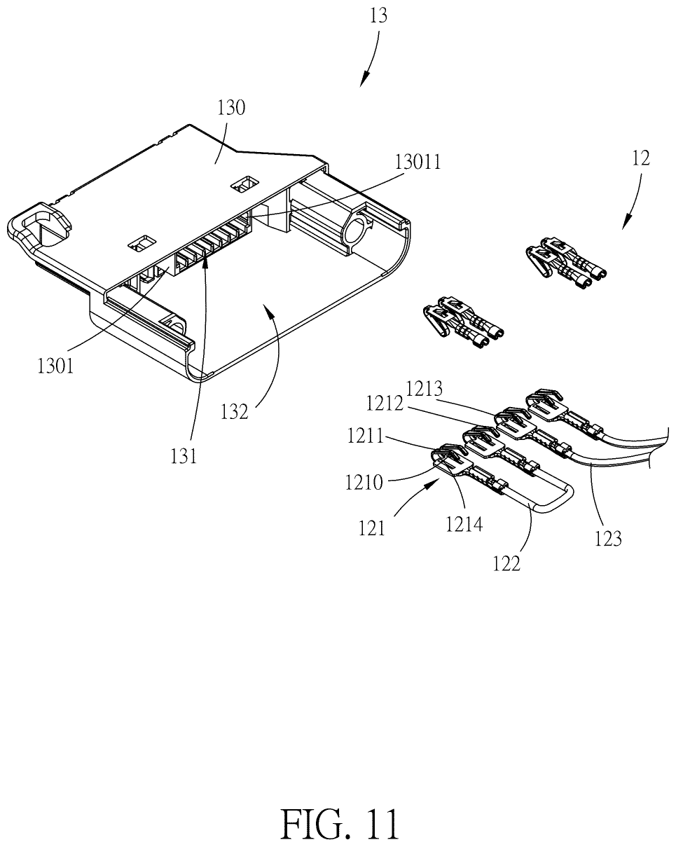

In the embodiment shown in FIGS. 11 to 13, the electrical connector housing body 130 comprises a housing body support frame 1301. The housing body support frame 1301 is located between the major-side housing assembly space 131 and the minor-side housing assembly space 132. The housing body support frame 1301 extends along the periphery of the major-side housing assembly space 131 to form a drawer structure capable of accommodating the major-side electrical connector subcomponent 11. Correspondingly, the housing body support frame 1301 comprises a housing body support frame guiding structure 13011. The housing body support frame guiding structure 13011 can guide the major-side electrical connector subcomponent 11 into the major-side housing assembly space 131, thereby preventing excessive interference as the major-side electrical connector subcomponent 11 enters the major-side housing assembly space 131.

It should be noted that the electrical connector 1 assembles the major-side electrical connector subcomponent 11 and the minor-side electrical connector subcomponent 12 through the electrical connector insulation housing 13. The major-side electrical connector subcomponent 11 and the minor-side electrical connector subcomponent 12 are respectively equipped with conductive terminals. Therefore, by altering the conductive terminals of the major-side conductive terminal assembly 111 and the minor-side electrical connector subcomponent 12, the number and configuration of the conductive terminals in the electrical connector 1 can be customized to meet the requirements of electronic devices.

It should be noted that the components of the above-described embodiments of the electrical connector in this application may be partially omitted. For example, in the embodiments of this application, the electrical connector may comprise: a major-side electrical connector subcomponent, a minor-side electrical connector subcomponent, and an electrical connector insulation housing. The major-side electrical connector subcomponent comprises a major-side conductive terminal assembly, a major-side circuit board, a major-side processing module, and a major-side insulation carrier. The major-side circuit board comprises a major-side bridging circuit and a major-side non-bridging circuit. The major-side processing module has major-side processing module bridging pins and major-side processing module non-bridging pins. The major-side conductive terminal assembly comprises a major-side conductive terminal assembly inserting section, a first major-side bridging conductive terminal, a second major-side bridging conductive terminal, and major-side non-bridging conductive terminals. The major-side insulation carrier comprises a major-side carrier embedded space. The major-side bridging circuit is electrically connected to the first and second major-side bridging conductive terminals to transmit major-side bridging signals. The major-side non-bridging circuit is electrically connected to the major-side non-bridging conductive terminals to transmit major-side non-bridging signals. The major-side processing module bridging pin is electrically connected to the major-side bridging circuit, and the major-side processing module non-bridging pin is electrically connected to the major-side non-bridging circuit, enabling the major-side processing module to receive and process major-side bridging signal and major-side non-bridging signal. The major-side insulation carrier accommodates the major-side circuit board, the major-side conductive terminal assembly, and the major-side processing module, while the major-side carrier embedded space provides a space to embed at least part of the major-side processing module. The minor-side electrical connector subcomponent comprises a minor-side conductive terminal assembly, which has a minor-side conductive terminal assembly inserting section. The electrical connector insulation housing comprises an electrical connector housing body, a major-side housing assembly space, a minor-side housing assembly space, a major-side housing inserting space, and a minor-side housing inserting space. The electrical connector housing body guides the major-side electrical connector subcomponent into the major-side housing assembly space, allowing the major-side conductive terminal assembly inserting section to enter the major-side housing inserting space. The electrical connector housing body also guides the minor-side electrical connector subcomponent into the minor-side housing assembly space, allowing the minor-side conductive terminal assembly inserting section to enter the minor-side housing inserting space. Additionally, the electrical connector housing body guides the inserting component to be inserted, enabling the major-side inserting component inserting section to enter the major-side housing inserting space to insert the major-side conductive terminal assembly inserting section, and the minor-side inserting component inserting section to enter the minor-side housing inserting space to insert the minor-side conductive terminal assembly inserting section.

In summary, this application provides an electrical connector. The electrical connector is constructed by assembling multiple components with conductive terminals. Thus, by altering the number of conductive terminals in the assembled components, the number of conductive terminals in the electrical connector can be customized to meet the requirements of electronic devices. Furthermore, the electrical connector comprises a circuit board electrically connected to the conductive terminals, and the circuit board is equipped with a processing module capable of processing signals, ensuring that the electrical characteristics of the electrical connector meet the requirements of electronic devices.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector, the electrical connector can allow an inserting component to insert in order to transmit a major-side bridging signal and a major-side non-bridging signal, the inserting component comprises a major-side inserting component inserting section and a minor-side inserting component inserting section, the electrical connector comprises:
a major-side electrical connector subcomponent, the major-side electrical connector subcomponent comprises a major-side conductive terminal assembly, a major-side circuit board, a major-side processing module, and a major-side insulation carrier, the major-side circuit board comprises a major-side bridging circuit and a major-side non-bridging circuit, the major-side processing module comprises a major-side processing module bridging pin and a major-side processing module non-bridging pin, the major-side conductive terminal assembly comprises a major-side conductive terminal inserting section, a first major-side bridging conductive terminal, a second major-side bridging conductive terminal, and a major-side non-bridging conductive terminal, the major-side insulation carrier comprises a major-side carrier embedded space, wherein the major-side bridging circuit is electrically connected to the first major-side bridging conductive terminal and the second major-side bridging conductive terminal to transmit the major-side bridging signal; the major-side non-bridging circuit is electrically connected to the major-side non-bridging conductive terminal to transmit the major-side non-bridging signal; the major-side processing module bridging pin is electrically connected to the major-side bridging circuit, and the major-side processing module non-bridging pin is electrically connected to the major-side non-bridging circuit, enabling the major-side processing module to respectively receive the major-side bridging signal and the major-side non-bridging signal for processing; and the major-side insulation carrier provides support for the major-side circuit board, the major-side conductive terminal assembly, and the major-side processing module, while the major-side carrier embedded space provides embedding for at least a portion of the major-side processing module;
a minor-side electrical connector subcomponent, the minor-side electrical connector subcomponent comprises a minor-side conductive terminal assembly, and the minor-side conductive terminal assembly comprises a minor-side conductive terminal inserting section; and
an electrical connector insulation housing, the electrical connector insulation housing comprises an electrical connector housing body, a major-side housing assembly space, a minor-side housing assembly space, a major-side housing inserting space, and a minor-side housing inserting space; the electrical connector housing body can guide the major-side electrical connector subcomponent into the major-side housing assembly space, so as to enable the major-side conductive terminal inserting section to enter the major-side housing inserting space, and the electrical connector housing body further guides the minor-side electrical connector subcomponent into the minor-side housing assembly space, enabling the minor-side conductive terminal inserting section to enter the minor-side housing inserting space; the electrical connector housing body further guides the inserting component, enabling the major-side inserting component inserting section to enter the major-side housing inserting space and insert the major-side conductive terminal inserting section, and further enabling the minor-side inserting component inserting section to enter the minor-side housing inserting space and insert the minor-side conductive terminal inserting section.

2. The electrical connector of claim 1, wherein the electrical connector further comprises an electrical connector cover, the electrical connector cover comprises a major-side electrical connector cover stop structure and a minor-side electrical connector cover stop structure, and the electrical connector cover can insert the electrical connector insulation housing, enabling the major-side electrical connector cover stop structure to provide stopping for the major-side electrical connector subcomponent to prevent the major-side conductive terminal inserting section from leaving the major-side housing inserting space, and further enabling the minor-side electrical connector cover stop structure to provide stopping for the minor-side electrical connector subcomponent to prevent the minor-side conductive terminal inserting section from leaving the minor-side housing inserting space.

3. The electrical connector of claim 1, wherein the electrical connector is further able to transmit a minor-side bridging signal and a minor-side non-bridging signal, the minor-side electrical connector subcomponent further comprises a minor-side bridging cable and a minor-side non-bridging cable, the minor-side conductive terminal assembly comprises a first minor-side bridging conductive terminal, a second minor-side bridging conductive terminal, and a minor-side non-bridging conductive terminal, wherein the minor-side bridging cable is electrically connected to the first minor-side bridging conductive terminal and the second minor-side bridging conductive terminal to transmit the minor-side bridging signal, and the minor-side non-bridging cable is electrically connected to the non-bridging conductive terminal to transmit the minor-side non-bridging signal.

4. The electrical connector of claim 3, wherein the electrical connector further comprises an electrical connector cover, the electrical connector cover comprises a cover threading passage, wherein the minor-side non-bridging cable passes through the electrical connector cover via the cover threading passage.

5. The electrical connector of claim 1, wherein the first major-side bridging conductive terminal, the second major-side bridging conductive terminal, and the major-side non-bridging conductive terminal are respectively inserting terminals for inserting the major-side circuit board or soldering terminals for soldering the major-side circuit board.

6. The electrical connector of claim 1, wherein the major-side insulation carrier further comprises a major-side carrier positioning structure, the major-side carrier positioning structure provides positioning for the major-side circuit board to prevent the major-side processing module from being misaligned with the major-side carrier embedded space.

7. The electrical connector of claim 1, wherein the major-side insulation carrier comprises a major-side carrier assembly structure, the major-side carrier assembly structure is assembled to the electrical connector housing body to restrict the movement of the major-side electrical connector subcomponent relative to the electrical connector housing body.

8. The electrical connector of claim 1, wherein the minor-side conductive terminal assembly comprises a minor-side conductive terminal assembly structure, the minor-side conductive terminal assembly structure is assembled to the electrical connector housing body to restrict the movement of the minor-side electrical connector subcomponent relative to the electrical connector housing body.

9. The electrical connector of claim 1, wherein the electrical connector housing body comprises a housing body support frame, the housing body support frame is located between the major-side housing assembly space and the minor-side housing assembly space, and the housing body support frame extends along the periphery of the major-side housing assembly space to form a drawer structure for supporting the major-side electrical connector subcomponent.

10. The electrical connector of claim 9, wherein the housing body support frame comprises a housing body support frame guiding structure, and the housing body support frame guiding structure can guide the major-side electrical connector subcomponent into the major-side housing assembly space.
